(19) United States
(12) Patent Application Publication
(10) Pub. No.: US 2025/0170992 A1
(43) Pub. Date: May 29, 2025

(54) Landing Gear Lowering and Retraction Automation Tool

(71) Applicant: Steven Dwight Davis, Eastvale, CA (US)

(72) Inventor: Steven Dwight Davis, Eastvale, CA (US)

(21) Appl. No.: 18/519,710

(22) Filed: Nov. 27, 2023

(51) Int. Cl. B25F 3/00

(52) U.S. Cl. CPC B60S 9/06; B25F 3/00

(57) ABSTRACT

The present invention is a uniquely customized tool for lowering and raising the landing gear on a trailer using an electrically operated drill/driver. This invention requires minimal effort to lower and retract the landing gear, because it utilizes a portable power tool which eliminates the manual effort of the process. The tool is connected to the landing gear lowering elements and is used to extend and retract the landing gear by pressing the trigger of the electrically operated drill/driver. The tool is attached to the landing gear element of a trailer with a cotter pin.

### CROSS-REFERENCE TO RELATED APPLICATIONS

This application is connected to design patent application Ser. No. 29/828,295.

### STATEMENT REGARDING PRIOR DISCLOSURES BY THE INVENTOR OR JOINT INVENTOR

Inventor disclosed the present invention to several engineers throughout 2023 and to Southern California Edison in October 2023.

### BACKGROUND OF THE INVENTION

### Technical Field

This invention relates generally to a tool for lowering and/or retracting the landing gear of a trailer.

This invention relates more particularly to an apparatus/device for lowering and/or retracting the landing gear of a trailer with minimal effort and maximum effect and uses a portable power tool which removes or eliminates the manual effort of the process.

### Background Art

Today the landing gear on a trailer is most commonly lowered and/or retracted by hand cranking the operationally connected handle to rotate the landing gear mechanism to lower and/or retract the foot plate to the ground. The tool for the landing gear is already attached to the device itself-it is a handle that is manually rotated to lower or retract the landing gear.

What is not present today is a powered tool that can lower and/or retract the landing gear.

In light of the foregoing prior art, there is a need for a tool to better lower and/or retract the landing gear on a trailer.

### BRIEF SUMMARY OF THE INVENTION

The present invention is a uniquely customized tool for lowering and raising the landing gear on a trailer.

According to a first aspect of the invention, there is a device configured for an extending and/or a retracting of a landing gear on a trailer comprising an electrically operated drill/driver without a bit or connection collar having a trigger and a cylindrical collar with a center oriented axially lengthwise comprising a first opening through said center having an open end with a sidewall, an entrance, and a connection end with a second opening through said sidewall proximal to said entrance opposite a third opening through said sidewall proximal to said entrance by a distance equal in measure wherein said open end and said connection end are connected by a fourth opening, and a cotter pin.

According to a second aspect of the invention there is a device configured for an extending and/or a retracting of a landing gear on a trailer wherein said cylindrical collar is 9.779 centimeters long, said first opening is not less than 2.5 centimeters in diameter through a first length of said open end, and said fourth opening is between 0.635 centimeters and 1.27 centimeters in diameter through a second length of said connection end.

According to a third aspect of the invention there is a device configured for an extending and/or a retracting of a landing gear on a trailer wherein said first length is 7.366 centimeters.

According to a fourth aspect of the invention there is a device configured for an extending and/or a retracting of a landing gear on a trailer wherein said second length is 1.651 centimeters.

According to a fifth aspect of the invention there is a device configured for an extending and/or a retracting of a landing gear on a trailer wherein said second opening and said third opening is 0.9906 centimeters in diameter.

According to a sixth aspect of the invention there is a device configured for an extending and/or a retracting of a landing gear on a trailer wherein said fourth opening is 0.635 centimeters in diameter.

According to a seventh aspect of the invention there is a device configured for an extending and/or a retracting of a landing gear on a trailer wherein said distance is 1.905 centimeters long.

According to an eighth aspect of the invention there is a device configured for an extending and/or a retracting of a landing gear on a trailer wherein said sidewall is 0.635 centimeters in diameter.

According to a ninth aspect of the invention there is a device configured for an extending and/or a retracting of a landing gear on a trailer wherein said electrically operated drill/driver operates cordlessly.

According to a tenth aspect of the invention there is a method of using the device of the present invention comprising: removing a crank handle from a landing gear shaft, attaching said device with a cotter pin to said landing gear shaft, pressing a trigger to either raise or lower a landing gear legs, removing said cotter pin, and removing said device.

Advantages of the present invention include easier, faster lowering of trailer landing gear and smoother operation of the landing gear lowering process and elements, resulting in fewer errors and safer operations of landing gear on trailers.

The invention will now be described, by way of example only, with reference to the accompanying drawings in which:

### BRIEF DESCRIPTION OF THE SEVERAL VIEWS OF THE DRAWINGS

FIG. 1 is a side view of the landing gear lowering and retraction automation tool cylinder collar according to the invention;

FIG. 2 is a is a top view of the landing gear lowering and retraction automation tool cylinder collar according to the invention;

FIG. 3 is a is a cross section view of the landing gear lowering and retraction

automation tool cylinder collar according to the invention;

FIG. 4 is a perspective view of the landing gear lowering and retraction automation tool cylinder collar according to the invention; and

FIG. 5 is a perspective view of the landing gear lowering and retraction automation tool cylinder collar attached to a drill creating a new tool according to the invention.

### DETAILED DESCRIPTION OF THE INVENTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Index of Labelled Features in Figures. Features are listed in numeric order by Figure in numeric order.

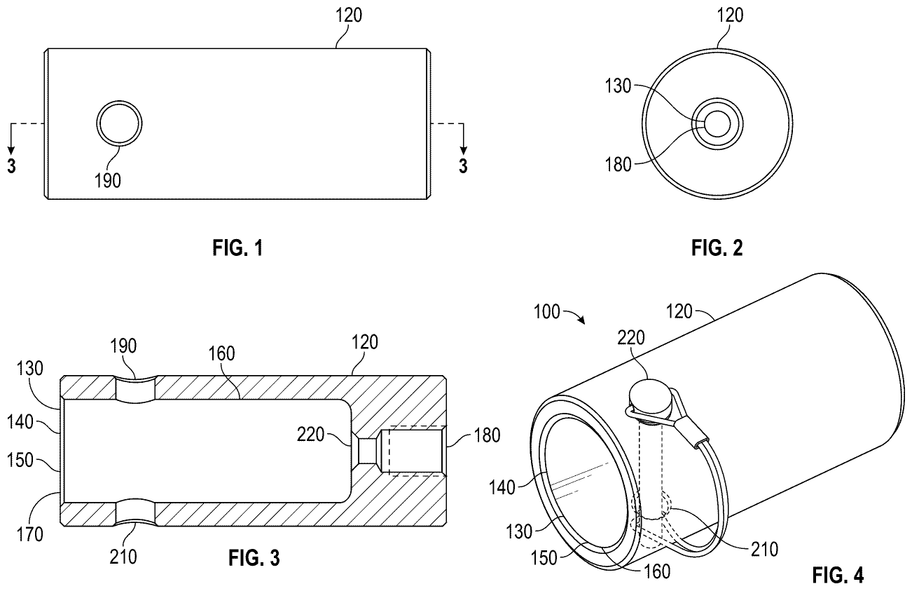

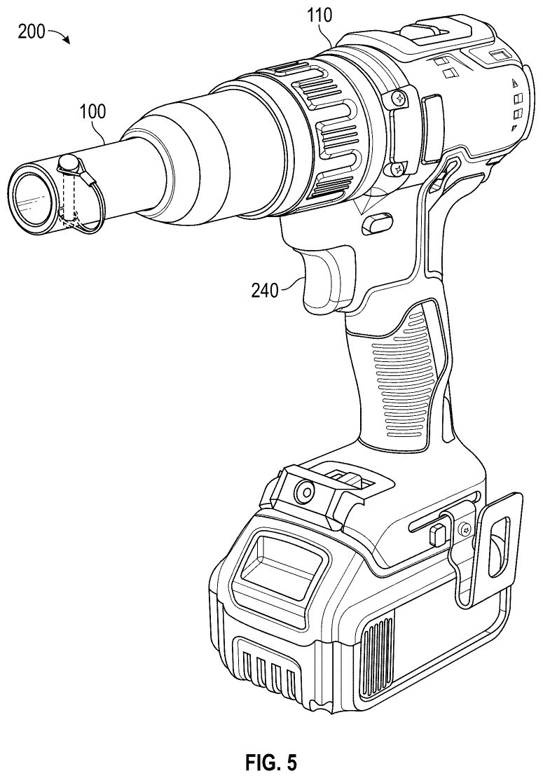

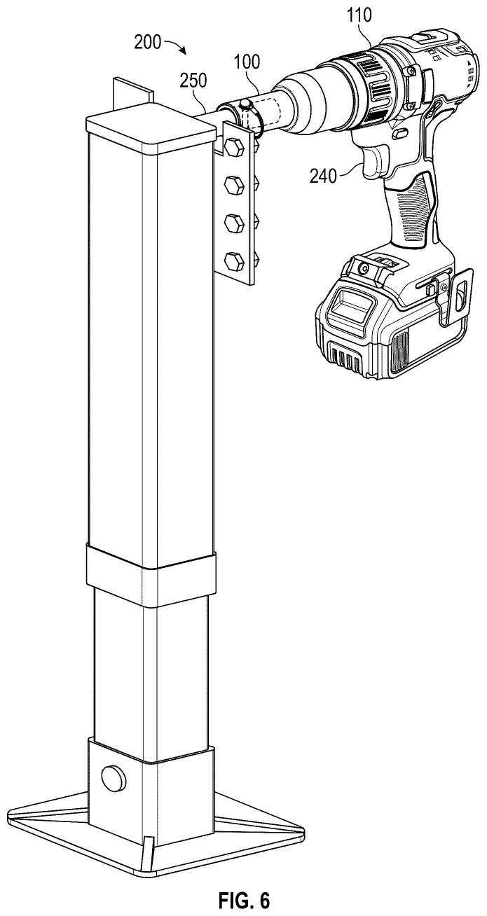

Referring to the Figures, there is shown in FIGS. 1, 2, 3, 4, and 5 the following features:
Element 100 which is a landing gear lowering and retraction automation tool cylindrical collar.
Element 110 which is an electrically operated drill/driver without a bit or connection collar.
Element 120 which is a cylindrical collar.
Element 130 which is a center.
Element 140 which is a first opening.
Element 150 which is an open end.
Element 160 which is a sidewall.
Element 170 which is an entrance.
Element 180 which is a connection end.
Element 190 which is a second opening.
Element 200 which is a cylindrical collar attached to drill/driver.
Element 2010 which is a third opening.
Element 220 which is a fourth opening.
Element 230 which is a straight cotter pin.
Element 240 which is a trigger.
Element 250 which is a landing gear shaft.

In an embodiment of the present invention there is an electrically operated drill/driver with a trigger and without a bit or connection collar that is used as a platform to install a customized fitted connection collar suited specifically for operational connection to a landing gear a trailer. The electrically operated drill/driver can be corded or cordless. The customized collar is a cylindrical collar with a center oriented axially lengthwise comprising a first opening through said center having an open end with a sidewall, an entrance, and a connection end with a second opening through said sidewall proximal to said entrance opposite a third opening through said sidewall proximal to said entrance by a distance equal in measure wherein said open end and said connection end are connected by a fourth opening.

The connection collar can be manufactured in from a single cylindrical piece of steel, and the openings are machined into a initial cylindrical solid piece of steel. The diameters and lengths of openings are as detailed below.

The open end is not less than 2.5 centimeters in diameter through a first length of 1.905 centimeter. The connection end is between 0.635 centimeters and 1.27 centimeters in diameter through a second length of said connection end. Said first opening is the end of the connection device that operationally connects to the landing gears lowering elements. Said second opening is the opening of the connection device that operationally connects to the electrically operated drill or driver.

In an embodiment of the invention there is a landing gear lowering tool wherein said said cylindrical collar is 9.779 centimeters long, said first opening is not less than 2.5 centimeters in diameter through a first length of said open end, and said fourth opening is between 0.635 centimeters and 1.27 centimeters in diameter through a second length of said connection end.

In an embodiment of the invention there is a landing gear lowering tool wherein said first length is 7.366 centimeters.

In an embodiment of the invention there is a landing gear lowering tool wherein said second length is 1.651 centimeters.

In an embodiment of the invention there is a landing gear lowering tool wherein said second opening and said third opening is 0.9906 centimeters in diameter.

In an embodiment of the invention there is a landing gear lowering tool wherein said fourth opening is 0.635 centimeters.

In an embodiment of the invention there is a landing gear lowering tool wherein said distance is 1.905 centimeters long.

In an embodiment of the invention there is a landing gear lowering tool wherein said sidewall is 0.635 centimeters in diameter.

The above dimensions are those as best suited for implementing the present invention as a single tool implemented for the widest range of landing gear apparatuses. These specific dimensions are an embodiment. Other dimensions suited or customized to any specific application can be based upon the dimensions of the elements of the landing gear to be automated by the addition of a tool as in the present invention.

In an embodiment of the invention there is a landing gear lowering tool wherein said electrically operated drill/driver operates cordlessly. The cordless version can be at least any of a battery pack operated or magnetically operated cordless driver or hand drill type device.

In an embodiment of the invention there is a method of using the device of the present invention comprising these five steps:
Removing a crank handle from a landing gear shaft;
Attaching said device with a cotter pin to said landing gear shaft;
Pressing a trigger to either raise or lower a landing gear legs;
Removing said cotter pin; and
Removing said device.

To use the device of the present invention the open end of the connection collar is connected to the rotating drive element of the landing gear lowering device. This is usually done by placing the open end or connection end of the at the connection end of landing gear crank handle to the lowering drive. The connection end of the present tool then rotates the lowering drive instead of using the manual handle. The four steps to use the invention are:
1. Remove crank handle from landing gear shaft;
2. Attach the invention (2nd Gen TurnNBurn) with cotter pin, wirelock pin, or nut and bolt to the landing gear shaft;
3. Press trigger to either raise or lower landing gear legs; and
4. Remove the cotter pin and remove the invention.

To use the device of the present invention, start by removing the crank handle from landing gear shaft. Then attach the device with a wirelock pin/nut and bolt/straight cotter pin to the landing gear shaft by placing the open end or the connection end to the lowering drive. The connection end of the present tool then rotates the lowering drive instead of using the manual handle to lower the landing gear. After the landing gear is lowered, the user can remove the attachment and remove the device of the present invention from the landing gear shaft.

An advantage of the present invention includes easier lowering of a trailer landing gear because the tool of the present invention is powered and does not require manual effort to use. Another advantage of the present invention includes faster lowering of trailer landing gear because the tool of the present invention is powered. Further, an advantage of the present invention is smoother operation of the landing gear lowering process and elements because the tool of the present invention is uniquely customized to fit said landing gear and is powered and does not require manual effort to use.

The advantages of the present invention include fewer errors and safer operations of landing gear on trailers because the tool of the present invention is uniquely customized to fit said landing gear and it is powered and does not require manual effort to use.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1-10. (canceled)

11. A landing gear automation device configured for extending and/or retracting a landing gear on a trailer, comprising:
an electrically operated drill/driver,
a cylindrical collar attached to said electrically operated drill/driver, said cylindrical collar being 9.779 centimeters long and having a first opening not less than 2.5 centimeters in diameter through a first length of an open end of said cylindrical collar,
said cylindrical collar comprising an arrangement of a plurality of strategically positioned openings, including a second opening and a third opening, each having a diameter of 0.9906 centimeters, and a fourth opening having a diameter of 0.635 centimeters, wherein said arrangement of said plurality of strategically positioned openings is configured to facilitate easy insertion and secure locking of a cotter pin,
said cotter pin configured to securely attach said cylindrical collar to a landing gear shaft by passing said cotter pin through said arrangement of said plurality of strategically positioned openings in said cylindrical collar and said landing gear shaft to provide a secure and stable connection, wherein the dimensions and placement of said plurality of strategically positioned openings are optimized to ensure rotational stability, ease of operation, and enhanced security during an extension and a retraction of said landing gear.

12. The landing gear automation device of claim 11, wherein said cylindrical collar is 9.779 centimeters long and said first opening is not less than 2.5 centimeters in diameter through a first length of said open end of said cylindrical collar, the dimensions being optimized to ensure a secure fit and enhanced rotational stability when interfaced with said landing gear shaft.

13. The landing gear automation device of claim 12, wherein said first length is 7.366 centimeters, the length being chosen to optimize the transfer of rotational force from said electrically operated drill/driver to said landing gear shaft, ensuring efficient and reliable operation.

14. The landing gear automation device of claim 12, wherein a second length of a connection end is 1.651 centimeters, the length being critical for maintaining the stability and structural integrity of said landing gear automation device during operation.

15. The landing gear automation device of claim 11, wherein said second opening and said third opening are each 0.9906 centimeters in diameter, the dimensions being integral for accommodating said cotter pin and ensuring a secure and stable attachment to said landing gear shaft.

16. The landing gear automation device of claim 11, wherein said fourth opening is 0.635 centimeters in diameter, the dimension being crucial for maintaining the overall structural integrity of said cylindrical collar and ensuring secure interfacing with various landing gear shafts.

17. The landing gear automation device of claim 11, wherein the distance between said second opening and said third opening is 1.905 centimeters, the distance being critical for proper alignment and secure locking of said cotter pin during operation.

18. The landing gear automation device of claim 11, wherein said sidewall is 0.635 centimeters in diameter, the thickness being chosen to ensure durability and robustness during operation, contributing to the reliability of said landing gear automation device in various conditions.

19. The landing gear automation device of claim 11, wherein said electrically operated drill/driver operates cordlessly, providing enhanced mobility and ease of use in various operational environments, particularly in situations where access to power sources is limited or where quick and efficient operation is required.

20. A method of using a landing gear automation device to extend and/or retract a landing gear on a trailer, comprising:
removing a crank handle from a landing gear shaft,
attaching said landing gear automation device with a cotter pin to said landing gear shaft by passing said cotter pin through an arrangement of a plurality of strategically positioned openings in a cylindrical collar of said landing gear automation device and said landing gear shaft to provide a secure and stable connection,
pressing a trigger on a cordless drill/driver to either raise or lower at least one landing gear leg,
removing said cotter pin, and
removing said landing gear automation device,
wherein said method reduces manual labor and minimizes a risk of injury during an extension and/or a retraction of said landing gear by securely attaching said landing gear automation device to said landing gear shaft and facilitating controlled operation through a simple trigger press.
